(19) United States
(12) Patent Application Publication
(10) Pub. No.: US 2009/0239581 A1
(43) Pub. Date: Sep. 24, 2009

(54) Accelerometer-controlled mobile handheld device

(76) Inventor: Shu Muk Lee, Basking Ridge, NJ (US)

Correspondence Address: Shu M. Lee, 239 Spencer Rd., Basking Ridge, NJ, 07920, US

(21) Appl. No.: 12/383,161

(22) Filed: Mar. 19, 2009

Related U.S. Application Data
(60) Provisional application No. 61/070,534, filed on Mar. 24, 2008.
(60) Provisional application No. 61/135,306, filed on Jul. 17, 2008.

(51) Int. Cl. H04M 1/00; G09G 5/00; G05D 1/00; G01P 15/00

(52) U.S. Cl. 455/556.2; 345/211; 700/302; 702/141

(57) ABSTRACT

The present invention is directed to mobile handheld devices such as, for example, cell phones or personal digital assistants (PDAs) containing an accelerometer that sends a signal that causes the device to turn on.

This application claims the benefit of U.S. Patent Application No. 61/070,534 filed Mar. 24, 2008, and U.S. Patent Application No. 61/135,306 filed Jul. 17, 2008.

### BACKGROUND OF THE INVENTION

The present invention is directed to mobile handheld devices containing an accelerometer. In particular, the present invention is directed to mobile handheld devices such as, for example, cell phones or personal digital assistants (PDAs) containing an accelerometer that sends a signal that causes the device to turn on.

Mobile handheld devices are small units, often carried in pockets or handbags, with limited power storage. Thus, inadvertently switching the unit on can lead to shortened battery life, with the device possibly running out of power at an inconvenient moment. It is an object of the present invention to do away with the need for an external power on-switch.

Some mobile handheld devices cover the display and the power button with a lid hinged on a side dimension of the device (clam-shell design). Other designs swivel the covering lid about an axis to reveal the display and/or power button. It is an object of the present invention to increase convenience by doing away with the need for a lid to protect the power switch.

The clam-shell design's cover lid can be opened by flicking the user's wrist while holding the lower non-lid portion of the clam-shell mobile handheld device, thereby causing the lid to swivel about the hinge and cease motion at a perturbing stop. However, while the flicking action may give the user stylish satisfaction, such action is discouraged because the delicate hinge and cover can be broken by such action. It is an object of the present invention to encourage such flicking action as a way stylishly to turn a mobile handheld device of the present invention on without subjecting the device to unintended increased wear.

While certain mobile handheld devices can resize pictures according to whether the device's display is held in a vertical (portrait) position or a horizontal (landscape) position, the devices are responding to the relative position of the display to the ground, not to a change in velocity (acceleration/deceleration). It is an object of the present invention to provide a mobile handheld device that responds to changes in velocity. Such changes in velocity may include a rotational component.

Accelerometers are well known in the art. An accelerometer may sense changes in velocity directly through interrogation or receipt of signal from an inertial transducer. An accelerometer may also calculate changes in velocity from data received from position sensing transducers. Accelerometers are often electromechanical devices and can measure the static gravitational force or dynamic forces caused by changes in speed and/or direction (changes in velocity). Presently, a few laptop computers are equipped with an accelerometer that turns of the hard drive when a sudden freefall is detected, thereby preventing the hard drive's head from crashing onto and damaging the hard drive platter.

Accelerometers can utilize the piezoelectric effect and can detect acceleration in three orthogonal axis, as well as rotation about the axis. The three orthogonal axis and the rotation about each are shown in FIG. 2. Further, accelerometers can provide analog outputs or digital outputs. One in the art readily can use either type of output, and modify the output accordingly to implement the present invention.

Accelerometers are commonly used in cars to trigger safety airbags when a collision occurs. The accelerometers are set so that mild decelerations do not trigger the airbag to deploy. Further, the accelerometers are commonly set to distinguish the direction or velocity of the deceleration (or acceleration) so that the airbags do not deploy inappropriately. Thus, accelerometer technology is known in the art, including how to set limits, both high and low, as well as directional, to how the signals from the accelerometer are used. However, automobiles are not battery operated handheld devices.

There are handheld devices that incorporate global positioning systems (GPS). Such GPS functions can calculate speed and direction. However, the precision is limited to greater than 1 meter because GPS require interrogation of a system of orbiting satellites. Thus, unlike the devices of the present invention, which incorporate accelerometers, the GPS devices cannot respond to changes in velocity within approximately a meter of any reference position of the device. For example, waving a GPS device about at arm's length will not change the position, speed, or acceleration information sensed or calculated by the GPS.

There are handheld devices that are used in video game systems, which incorporate position and motion detectors in order to communicate with a central game control computer that provides appropriate signals to a video display to show images responsive to the position and motion detectors. However, such handheld devices require a separate control computer and do not use the position and motion detectors to control a function of the handheld device itself.

It is well known that, in a graphical plot of distance versus time, speed is the slope of distance versus time. Velocity is speed with a direction component (vector). Acceleration is the slope of speed versus time. Deceleration is just negative acceleration. Further, when an object is not travelling in a straight line, acceleration is also the change in velocity versus time.

There are cell phones and other handheld battery powered devices made by, for example, Apple, Inc. that includes an accelerometer. However, none advantageously prevents unintended powering-on of the device by avoiding the use of a power-on button and advantageously using the accelerometer to turn the device on according to the present invention.

There are cell phones and other handheld battery powered devices made by, for example, Motorola, Inc. that has an off mode in which the device maintains negligible power in order to keep a function active such as a timed alarm. Thus, when the device is set to produce an alarm at, for example 6:00 AM and the device is turned off, the device nevertheless will appropriately turn itself on at 6:00 AM and sound an alarm as programmed. Thus, quiescent off modes in which the device is off, using negligible power, but able to keep power to a desired functionality are known in the art.

### SUMMARY OF THE INVENTION

The present invention is directed to mobile handheld devices such as, for example, cell phones or personal digital assistants (PDAs) containing an accelerometer that sends a signal that causes the device to turn on.

### BRIEF DESCRIPTION OF THE DRAWINGS

The invention may be put into practice in various ways, one of which will now be described by way of example only and with reference to the accompanying drawings in which:

FIG. 1 shows a block diagram of a mobile handheld device according to the disclosure; and

FIG. 2 shows possible axes of movement of the mobile handheld device of FIG. 1.

### DETAILED DESCRIPTION OF THE INVENTION

The present invention is directed to mobile handheld devices containing an accelerometer. The mobile handheld device of the invention is responsive to signals from the accelerometer. The mobile handheld device of the invention includes an energy storage unit such as, for example, conveniently a battery to supply power to allow the mobile handheld device to respond to a signal from the accelerometer. Instead of a battery, the energy storage unit may be a capacitance storage unit

The present invention is directed to mobile handheld devices such as, for example, cell phones or personal digital assistants (PDAs) containing an accelerometer that sends a signal that causes the device to turn on.

The accelerometer may be conveniently made very small by means of manufacturing techniques found in the field of micro-electro-mechanical systems (MEMS). The field of accelerometers is well known. While the present invention can be practiced using a two-axis accelerometer, such use will limit the type of input that the device of the present invention can respond to. For more complex inputs, it is preferred that a three axis accelerometers or two two-axis accelerometers mounted at right angles be used. The accelerometer should have a dynamic range (be capable of measuring) of ±1.5 g to ±5 g (g is Earth's gravity at sea level). Less than ±1.5 g might not provide enough headroom, while more than ±5 g likely is not needed as the device itself may be damaged above that acceleration level.

The accelerometer can conveniently be capacitive, piezoelectric, piezoresistive, magnetoresistive, or utilize the Hall effect, or the tracking of heat transfer. Furthermore, the characteristics of the accelerometer such as linearity, sensitivity, input voltage, ratiometric factor, impedance, frequency response, high frequency limit, low frequency cutoff, noise, buffering needs, resonance frequency, temperature sensitivity and range, and bandwidth are readily and conveniently determinable by one in the art for suitability to the device of the invention. It is preferred that the bandwidth or sampling rate be above about 200 Hz, although one in the art ready and conveniently can determine the needed bandwidth for a particular application in the device of the present invention.

In one aspect, the present invention is a mobile hand-held device that comprises a visual display and an accelerometer; wherein the display is made operational by a signal from the accelerometer.

In another aspect, the present invention is a mobile hand-held device that comprises an accelerometer and a computer, wherein the computer includes a program that teaches the device a movement sequence, conveniently entered by the user, that can be stored for access later as being the movement sequence required to perform a conveniently desired function, such as turning the device on, of the device.

In an embodiment of the invention, a mobile handheld device has a touch screen and contains an accelerometer. When the user has finished using the device, the user touches an off icon on the screen causing the device to enter into a “quiescent off” mode. A quiescent off mode is one in which the device is essentially off, with negligible power or relatively low power consumption, maintained to allow the device to turn on in response to a signal from the accelerometer. When the user wishes to use the device, the device is caused to undergo a change in velocity sufficient to cause the accelerometer to turn the device on for use. In an “on” mode, the device has a relatively high power consumption, when compared with the “quiescent off” mode.

The change in velocity required to cause purposefully the accelerometer to turn the device on should be set at a level or condition sufficient to distinguish from movement of the device not meant by the user to turn the device on. For example, the accelerometer can be set to turn the device on when a particular corner of the device is tapped on a firm surface as distinguished from a different corner of the device being tapped. In this example, the ability of accelerometers to distinguish velocity changes in one direction from changes in a different direction is utilized to differentiate a purposeful acceleration/deceleration from a non-purposeful acceleration/deceleration. Furthermore, the accelerometer can be set so that a deceleration above a predetermined value would not trigger turning the device on. Thus, accidental drops of the device—even if inadvertently in the correct direction—would not turn the device on.

Advantageously, the device may be set to turn on when a particular tapping is repeated, thus distinguishing from a solo inadvertent tap.

As can be appreciated by the above example, the device of this invention can be placed in a pocket or handbag with minimal likelihood of it being accidentally turned on and inconveniently running the battery down. Furthermore, there are situations (such as a miniature hard-drive in which the drive is docked in a protected mode when off) in which having the device being off during inadvertent violent movements would be desirable. Thus, in an aspect of the invention, the accelerometer turns the device off when certain predetermined accelerations or decelerations are sensed by the accelerometer.

Further, the quiescent off mode can be one in which the device nevertheless can respond to external non-mechanical signals. For example, the device can ring when a call, text message, or page is sent to it. At that point, the user may turn the device on to answer or respond by causing the accelerometer to sense a purposeful change in acceleration or deceleration.

In another embodiment of the invention, a mobile handheld device contains an accelerometer. The device, in a quiescent off mode, may be turned on by causing the accelerometer to sense a flicking motion relative to an axis of the device. The flicking motion is similar to the motion one would make with a clamshell device in the art, which comprises a body and a covering lid hinged to the body at a hinge pivot, to flip open the covering lid. That is, such a clamshell device is caused to accelerate substantially about the hinge pivot of the covering lid. Then the body of the device is caused to decelerate such that the inertia of the lid about the hinge pivot opens the lid relative to the decelerated body of the device. This substantially rotational acceleration followed by deceleration can be programmed into the device of the present invention so that such flicking motion of the device causes the device to turn on. Thus, for example, the device in the quiescent off mode can ring when a call, text message, or page is sent to it. At that point, the user may turn the device on to answer or respond by causing the accelerometer to sense a purposeful change in rotational acceleration or deceleration caused by the flicking motion.

Further, in another embodiment of the invention, a mobile handheld device contains an accelerometer. The device may be turned on by causing the accelerometer to sense a first sequence of velocities and velocity changes. The device may then be switched to a different function by causing the accelerometer to sense a second sequence of velocities and velocity changes.

As an example, the first sequence may be a flicking motion as described above. The second sequence may be a rotation about an axis different from the flicking motion axis. Conveniently, the second sequence may be a rotation similar to what a person does in bringing a phone up to a position by the ear from a position about hip height.

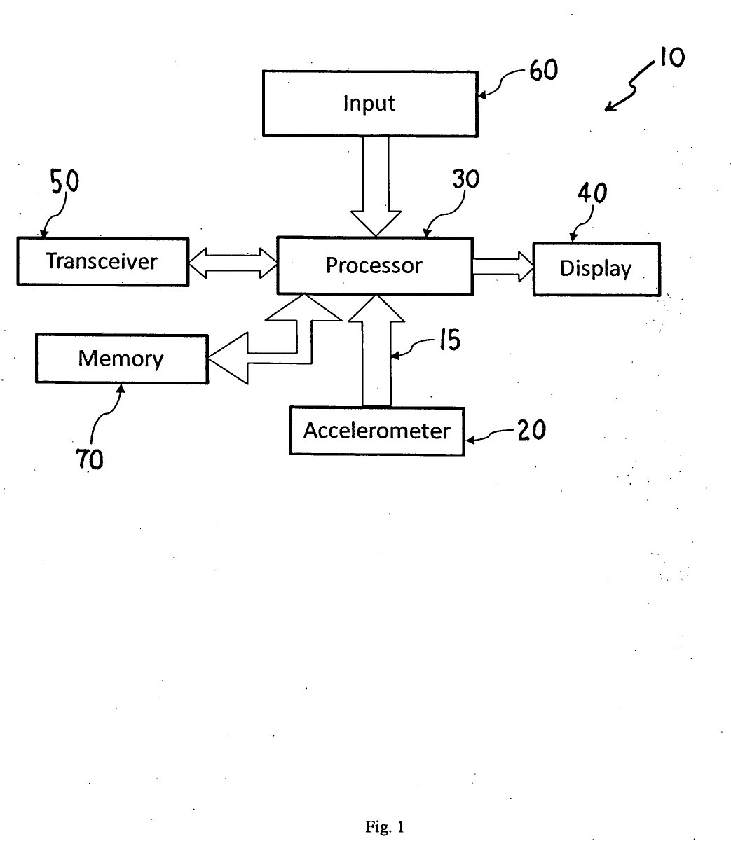

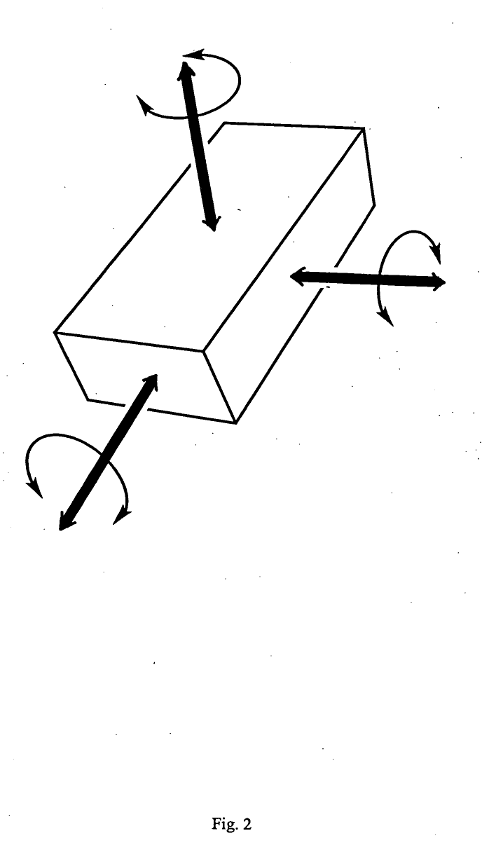

Referring now to FIG. 1, there is shown a block diagram of a mobile handheld device 10 according to the disclosure. The device 10 comprises: an accelerometer 20; and a processor 30. The accelerometer 20 is integrated within the device 10 and generates a signal 15, based on the acceleration experienced by the device 10. The generated signal 15 is provided to the processor 30. When the processor 30 receives the acceleration signal 15, it processes this signal to identify whether the acceleration measured by the accelerometer meets at least one predefined criterion. FIG. 2 shows the possible axes of movement of the mobile handheld device of FIG. 1. The accelerometer 20 can detect motion in any of these axes.

The processor 30 is also coupled to, and operative to control a display 40, a transceiver 50, one or more input devices 60 and a memory 70. If the processor determines that an acceleration meeting a criterion has been detected, it performs a functionality. This functionality may be pre-programmed. In particular, the processor 30 may be operative to switch from the “quiescent, off ” mode to the “on” mode. During the “quiescent, off” mode, the processor may restrict its functionality based on signals from the input device 60 to a minimum level. The display 40, transceiver 50 and memory 70 may also have respective “quiescent, off” modes, in which their power consumption is reduced and functionality disabled. Moreover, by activation of these devices, the skilled person would understand that the device operates to perform its designated function. For example, the display 40 is activated to display information. Similarly, the transceiver 50 is activated to act as a receiver or a transmitter or both. The memory may be activated to output stored data or to store input data.

In order to determine whether a predefined criterion has been met, the processor 30 compares the accelerometer signal 15 with a reference signal. The reference signal may be set by a user in an initialization step. The user causes the mobile hand-held device to undergo a specific motion, thereby generating a signal from accelerometer 20, which can then be stored in memory 70 as a reference signal. The reference signal may be stored in the memory 70.

In regular operation, the processor 30 compares the acceleration signal 15 with the reference signal using a correlation. A tolerance value is used to account for the fact that it is unnecessary for a user to reproduce the reference signal exactly to allow effective operation.

The skilled person will contemplate various modifications. An alternative criterion for analysis of the acceleration signal 15 is to identify one or more characteristics of the signal. Signal processing techniques, for example a Fourier analysis, can be used to identify at least one characteristic and a criterion can be set based on the characteristic. This may allow more complex motions or a range of different but related motions to be identified on the basis of the accelerometer signal. Although the preferred accelerometer 20 has been described as capable of detecting motion in any of the three axes shown in FIG. 2, the skilled person will recognize that the present invention may be employed using an accelerometer capable of detecting acceleration in one or two of the three axes, or of measuring only limited directional or rotational acceleration in one or more of these axes.

The skilled person will appreciate that the display 40, transceiver 50, input device 60 are optional features of the mobile hand-held device 10, and depending on the functionality provided the mobile hand-held device 10, each of these devices may or may not be desirable. Moreover, the skilled person will recognize that the accelerometer 20 may be able to control each of these devices directly, without requirement for processor 30. For example, the skilled person will appreciate that the display 40 might comprise internal logic for automatic activation based on an accelerometer signal 15 directly from the accelerometer 20. Alternatively, a second processor may be provided for carrying out the determination steps of the invention. This processor may also be configured to control other devices within the mobile handheld device.

The disclosure therefore provides a method of operating a mobile hand-held device, the method comprising: detecting an acceleration of the mobile hand-held device using an accelerometer; and activating a functionality of the mobile hand-held device in response to the detected acceleration.

This method advantageously allows the mobile hand-held device to operate a function in response to a detected acceleration. Acceleration of the mobile hand-held device can therefore be used to control the device in a way that enables facilities within the device that were not previously operative. Thus, the acceleration signal is used to increase the user's range of functions for the device.

Optionally, the mobile hand-held device comprises a visual display and the step of activating a functionality of the mobile hand-held device comprises activating the visual display. Additionally or alternatively, the mobile hand-held device comprises a processor and the step of activating a functionality of the mobile hand-held device comprises activating a functionality of the processor. Optionally, the mobile hand-held device comprises a user input device, and the step of activating a functionality of the mobile hand-held device comprises activating the user input device to allow an input to be provided to the processor.

In the preferred embodiment, the mobile hand-held device is arranged to operate in a first mode with a first power consumption and a second mode with a second power consumption, the second power consumption being greater than the first power consumption, and wherein the step of activating a functionality comprises activating the second mode of the mobile hand-held device. Thus, the second mode provides additional functionality to the user that increases power consumption, until the user disables this functionality. Preferably, the processor is arranged to operate in a first mode with a first power consumption and a second mode with a second power consumption, the second power consumption being greater than the first power consumption, and wherein the step of activating a functionality of the processor comprises activating the second mode.

Advantageously, the method further comprises: generating a signal indicative of the acceleration of the mobile hand-held device using the accelerometer; determining, using the generated signal, that the acceleration of the mobile hand-held device meets a predefined criterion; and activating the functionality of the mobile hand-held device in response to the said determination. More preferably, the criterion can be a predefined acceleration and the step of determining comprises determining that the acceleration of the mobile hand-held device matches a predefined acceleration. Most preferably, the step of determining comprises performing a correlation between the generated signal and a reference signal indicative of the predefined acceleration. This correlation can use mathematical correlation techniques or algorithms based on such techniques. These may be techniques in the art of signal processing.

Optionally, the method further comprises, prior to the step of detecting an acceleration: causing a motion of the mobile hand-held device to generate the predefined acceleration; generating a reference signal indicative of the predefined acceleration of the mobile hand-held device using the accelerometer; and storing said reference signal. This allows the reference signal to be set by the user and the device to learn the users movements.

In some embodiments, the method further comprises: determining, using the generated signal, that the acceleration of the mobile hand-held device meets a second predefined criterion; and activating a second functionality of the mobile hand-held device in response to the said second determination. In this way, more than one functionality can be activated as a result of a single acceleration signal.

The disclosure also describes a computer, programmed to operate as defined in any of the above method steps. Additionally or alternatively, the disclosure also provides a computer memory element, comprising instructions, which when loaded onto a computer, cause it to operate as defined in any of the above method steps.

In a further aspect, the disclosure also comprises a mobile hand-held device, comprising an accelerometer that is arranged to detect an acceleration of the mobile hand-held device and to activate a functionality of the mobile hand-held device in response to the detected acceleration.

What is claimed:

1. A method of operating a mobile hand-held device, the method comprising:
detecting an acceleration of the mobile hand-held device using an accelerometer; and
activating a functionality of the mobile hand-held device in response to the detected acceleration.

2. The method of claim 1, wherein the mobile hand-held device comprises a visual display and the step of activating a functionality of the mobile hand-held device comprises activating the visual display.

3. The method of claim 1, wherein the mobile hand-held device comprises a processor and the step of activating a functionality of the mobile hand-held device comprises activating a functionality of the processor.

4. The method of claim 1, wherein the mobile hand-held device is arranged to operate in a first mode with a first power consumption and a second mode with a second power consumption, the second power consumption being greater than the first power consumption, and wherein the step of activating a functionality of the mobile hand-held device comprises activating the second mode.

5. The method of claim 1, further comprising:
generating a signal indicative of the acceleration of the mobile hand-held device using the accelerometer;
determining, using the generated signal, that the acceleration of the mobile hand-held device meets a predefined criterion; and
activating the functionality of the mobile hand-held device in response to the said determination.

6. The method of claim 5, wherein the step of determining comprises determining that the acceleration of the mobile hand-held deveice matches a predefined acceleration.

7. The method of claim 6, wherein the step of determining comprises performing a correlation between the generated signal and a reference signal indicative of the predefined acceleration.

8. The method of claim 7, further comprising, prior to the step of detecting an acceleration:
causing a motion of the mobile hand-held device to generate the predefined acceleration;
generating a reference signal indicative of the predefined acceleration of the mobile hand-held device using the accelerometer; and
storing said referenced signal.

9. The method of claim 5, further comprising:
determining, using the generated signal, that the acceleration of the mobile hand-held device meets a second predefined criterion; and
activating a second functionality of the mobile hand-held device in response to the said second determination.

10. A computer, programmed to operate as defined according to claim 1.

11. A mobile hand-held device, comprising an accelerometer that is arranged to detect an acceleration of the mobile hand-held device and to activate a functionality of the mobile hand-held device in response to the detected acceleration.

12. A mobile hand-held device comprising:
a visual display; and
an accelerometer; wherein the display is made operational by a signal from the accelerometer.

13. A mobile hand-held device comprising:
a cell phone or personal digital assistant containing an accelerometer that sends a signal that causes the cell phone or personal digital assistant to turn on.

14. A mobile hand-held device comprising:
an accelerometer;
a computer; and
a computer program that teaches the device a movement sequence that can be stored by the computer for access later as being the movement sequence required to perform a function of the device.
